(19) United States
(12) Patent Application Publication
(10) Pub. No.: US 2018/0172425 A1
(43) Pub. Date: Jun. 21, 2018

(54) HIGH DEFINITION OPTICAL COHERENCE TOMOGRAPHY IMAGING FOR NON-INVASIVE EXAMINATION OF HERITAGE WORKS

(71) Applicant: The Penn State Research Foundation, University Park, PA (US)

(72) Inventors: Yi Yang, Oreland, PA (US); Xuan Liu, Berkeley Heights, NJ (US)

(21) Appl. No.: 15/850,689

(22) Filed: Dec. 21, 2017

Related U.S. Application Data
(60) Provisional application No. 62/437,310, filed on Dec. 21, 2016.

(51) Int. Cl. G01B 9/02; G01B 11/24; G01N 21/95

(52) U.S. Cl. CPC G01B 9/02091; G01N 21/9515; G01B 11/2441

(57) ABSTRACT

A high-speed, high-definition optical coherence tomography (OCT) imaging system for non-invasive examination of an artwork in a macroscopic scale includes a high-speed, large field-of-view OCT imaging platform which includes a spectral domain OCT imaging system and a pair of linear motors configured to translate the artwork in two orthogonal directions creating a 2D stage system for scanning the artwork and acquiring volumetric OCT data from adjacent, non-overlapping Regions of Interests on the artwork. The linear motors each have an accuracy compatible with the lateral resolution of the OCT system. The imaging platform is operated at a high speed due to the Fourier domain configuration of the OCT system and parallelized signal processing enabled by a Graphic Processing Unit. The data acquired by the system provides both 3D surface information of the artwork and structure information underneath the surface, providing a nondestructive alternative for the analysis and conservation of artworks.

### REFERENCE TO RELATED APPLICATION

This application claims priority from U.S. Provisional Patent Application Ser. No. 62/437,310, filed Dec. 21, 2016, the entire content of which is incorporated herein by reference.

### FIELD OF THE INVENTION

This invention relates to three-dimensional (3-D) microscopic imaging. More particularly, it relates to high-speed, large field of view (FOV) optical coherence tomography (OCT) imaging for various uses including non-invasive examination of heritage works.

### BACKGROUND

Three dimensional microscopic imaging has been used for examining many objects and things that require examination for diagnostic and other reasons. For example in the case of heritage works, such as historical oil paintings and ancient murals, these objects are routinely examined to determine the state of deterioration. Visual inspection can identify macroscopic, superficial defects of the objects. However current state of the art examination lacks the capability of monitoring microscopic or subsurface deterioration. In addition, the efficacy of visual inspection largely depends on the training and experience of the examiner [1]. In current standard practice of microscopic examination, small samples are acquired from paintings or murals and then assessed under microscope. The inherent invasiveness and extremely low sampling rate of this method limits its applications [1]. In addition the invasive nature of these methods adulterates the object under examination.

Previous optical methods have been implemented to assist with conservation efforts. For instance, 3D scanning of the target work is used to compare the state of degradation of the original piece [2]. Cross-sectional imaging technologies, such as X-Ray computer tomography or magnetic resonance imaging, allow the internal structure of the cultural heritage objects to be revealed. However these methods also have many documented disadvantages and drawbacks. For example, those current methods of examination lack spatial resolution for microscopic examination [3 and 4].

Optical coherence tomography (OCT) is a three-dimensional (3D) imaging modality with microscopic resolution [5 and 6]. It has found a variety of clinical applications, for example, in ophthalmology, interventional cardiology and other fields of biomedicine [7]. The unique capabilities of OCT also open new possibilities in the field of cultural heritage conservation [8]. OCT acquires depth resolved signals with micrometer resolution from the sample without contacting the object for cross-sectional imaging. The noninvasive nature of this technology provides an extra layer of safety when it is used to analyze delicate cultural heritage objects. Therefore, critical surface or subsurface features and structure information can be collected using OCT for diagnostic applications of historical oil paintings and murals, such as subsurface damage to the artwork or invisible underdrawings beneath the superficial layers. For instance, cross-section images obtained through this method are used for varnish layer and structural analysis [9 and 10]. Other capabilities such as identifying layer structure of ancient mural, revealing the underdrawings and their depth positions of paintings [11], and vanish thickness measurement [10] have been demonstrated.

However, OCT has limited capability in high definition (HD) examination. For example HD examination of historical oil paintings that is in macroscopic scale tends to produce poor resolution using current OCT methods and systems. The challenge comes from the small field of view (FOV) of OCT imaging, the data acquisition and processing speed for HD examination.

A large FOV can be achieved by using an imaging objective with a large focal length. However, this alternative method may reduce the lateral resolution if the diameter of the lens remains the same, or increases the footprint of the imaging instrument if the numeric aperture of the lens remains constant.

Previous works by Liang et al investigated the application of OCT in art conservation and archaeology, which was limited by the slow imaging speed of time domain OCT system [8, 15].

Therefore, a need exists for a non-invasive microscopy technology that is capable of acquiring high definition data from a large area and large field of view. There also still remains a need in the art for a technology to process such data acquired and provide high definition spatial resolution for a microscopic examination.

### SUMMARY OF THE INVENTION

HD examination of heritage works needs to scan large areas and process huge amount of data in a macroscopic scale. The present invention solves the problems of current state of the art of microscopy technology and provides many more benefits.

To advance the application of OCT for the examination of heritage works, a high-speed, large field-of-view (FOV) OCT imaging platform is provided. Huge volumes of data acquired from the OCT engine is processed by a high speed software based on a graphic processing unit (GPU) [12]. Hence to achieve large FOV that utilize large amounts of data, an object or sample is translated with a pair of linear motors to acquire OCT data from adjacent, non-overlapping areas, while the lateral resolution and sensitivity of OCT imaging is not compromised.

In the field of art conservation, both the surface profile and the under layer structural information is need.

We present a system that is capable of simultaneously acquire the surface profile and under layer structural information of art works. To acquire the under layer structural information, the B scan obtained from OCT scanning of the object is used. The 3D OCT data is used to render the surface topology of the painting, which captures the brush stroke characteristic of the painter. Peak search is performed for each Ascan in the software to identify the peaks at each Ascan, which produces the 3D surface profile.

The proposed system can acquire a cross-section information of the art work by making a virtual cut. OCT acquires depth resolved signals with micrometer resolution from the sample without contacting the object for cross-sectional imaging. The noninvasive nature of this technology provides an extra layer of safety when it is used to analyze delicate cultural heritage objects. Therefore, critical surface or subsurface features and structure information can be collected using OCT for diagnostic applications of historical oil paintings and murals, such as subsurface damage to the artwork or invisible underdrawings beneath the superficial layers

The virtual cut can be made by scanning the artwork along a defined pathway, where B scan is obtained from the painting along the path and cross-section information is obtained.

In order to study under layers of the art works, the current technology provides a solution to do a virtual layer peel, which can display structural information of the under layers at different depth. The large FOV enface images of different layers can be generated by averaging pixel values within different depth range. The layer information can be displayed according to their depth without any invasive methods.

The present application discloses a system and method of optical coherence tomography (OCT) as a non-invasive microscopy technology for the identification, conservation and restoration of heritage works. The present system is capable of acquiring and processing high definition (HD) data from a large area. The data acquired by the present OCT imaging system may be processed and provides both 3D surface information of the object and structure information underneath the surface, provides a way for non-invasive examination of an artwork.

The present invention provides a high-speed, large field-of-view (FOV) OCT imaging platform including a spectral domain OCT imaging system and a pair of linear motors configured to translate the artwork in two orthogonal directions creating a 2D stage system.

The spectral domain OCT imaging system may include a pair of galvanometers for steering a light beam to perform lateral scanning.

By scanning the artwork in X and Y directions, volumetric OCT data is acquired from adjacent, non-overlapping Regions of Interests (ROIs) on the artwork.

The linear motors each have an accuracy compatible with the lateral resolution of the OCT system, the linear motors remaining still during the spectral data acquisition such that the lateral resolution of the OCT system may be preserved and not be compromised.

An Ascan from each optical interface may be obtained by a Fourier domain configuration of the spectral domain OCT imaging system based on the spectral data acquired.

The imaging platform further includes a Graphic Processing Units (GPU). Each Ascan may be processed by an individual core of the GPU, thereby enabling parallel signal processing.

Both the high speed of data acquisition due to the high speed of the motors and the high speed of the data processing due to the parallel data processing contribute to the high speed of the OCT imaging system of the present invention.

The system may further include an achromatic doublet with an anti-reflective coat in near infrared range used as an imaging objective having a focal length (F_{obj}) of e.g. 60 mm.

After data acquisition from a current ROI is accomplished, the motors translate to an adjacent ROI to acquire additional volumetric OCT data.

The acquisition of OCT data and translation of the motors may be controlled by a software program developed for the present invention. The motors may be programmed to translate to pre-determined spatial coordinates. The motors may be programmed so that movement is in x and/or y directions with a displacement equivalent to the FOV.

The present invention achieves a large FOV OCT imaging system attributed to a large displacement of the motors. An upper limit of the FOV may be determined by a travel range of the motor.

The FOV may be determined by the maximum deflecting angle (αₘₐₓ) of a galvanometer and a focal length (F_{obj}) of an objective lens. αₘₐₓ is determined by a specification of the galvanometer. αₘₐₓ=βV, where β is a galvanometer's responsive factor, V is voltage applied to the galvanometer.

The amplitude of each Ascan signal may be averaged to convert volumetric OCT data into a 2D enface image for visualization.

A peak search may be performed for each Ascan producing the surface profile.

A series of the Ascans may be obtained across the structure of the artwork, generating a B scan of the artwork , which is cross-sectional information of the structure.

The present invention further provides a method of performing non-invasive examination of an artwork using a high speed, high definition optical coherence tomography (OCT) imaging system.

The method includes the step of providing a high-speed, large field-of-view (FOV) OCT imaging platform as disclosed herein.

The method includes performing a lateral scanning of a Region of Interest (ROI) on the artwork to acquire volumetric OCT data of the artwork using the OCT imaging platform.

After the data acquisition is done at the current ROI, the artwork may be translated to an adjacent non-overlapping ROI to acquire additional volumetric OCT data of the artwork.

The method may include constructing surface topology and subsurface microstructure of the artwork based on the volumetric OCT data acquired.

The method may include performing a fast Fourier transform (FFT) to obtain an Ascan based on the volumetric OCT data acquired.

The method may include obtaining a series of Ascan across a structure of the artwork for generating a cross-sectional Bscan.

The imaging platform described herein is operated at a much higher speed due to the Fourier domain configuration of the OCT system and parallelized signal processing enabled by GPU.

The disclosed invention imaging platform addresses the need for high-speed volumetric imaging in the examination of cultural heritage works, and other applications. This platform is a highly innovative application of OCT technology.

### BRIEF DESCRIPTION OF THE DRAWINGS

FIG. 1 is a diagram illustrating a configuration of an OCT imaging system in accordance with an embodiment of the present invention;

FIG. 2 is flow chart illustrating a data acquisition procedure of the OCT imaging system;

FIG. 3 is a bar graph illustrating analysis of signal processing time;

FIG. 4A is an image showing an enface OCT image of an USAF glass slide resolution targets;

FIG. 4B is a photo showing an USAF optical test pattern having four regions of interests (ROIs);

FIG. 4C is an image showing an enface OCT image of the four ROIs in FIG. 4B after mosaicking;

FIG. 5A is a plot showing an A_{scan} data obtained from a painting;

FIG. 5B is an image showing an enface image of the painting used in FIG. 5A, where scale bars shown indicate 0.5 mm;

FIG. 5C is an image showing a B_{scan} image of the painting used in FIG. 5A, where scale bars shown indicate 0.5 mm;

FIG. 6A is a photo showing an oil painting indicating a region of interest with a bold lined square;

FIG. 6B is an image showing the region of interest in FIG. 6A;

FIG. 6C is an image showing the region of interest in FIG. 6A with enface images of the painting after a penetration depth of 250 μm;

FIG. 6D is an image showing the region of interest in FIG. 6A with enface images of the painting after a penetration depth of 500 μm;

FIG. 6E is an image showing the region of interest in FIG. 6A with enface images of the painting after a penetration depth of 750 μm;

FIG. 6F illustrates the region of interest in FIG. 6A with enface images of the painting after a penetration depth of 1000 μm;

FIG. 7A is an image showing a structural image of a coin;

FIG. 7B is a 2-dimensional (2D) view showing a surface topography of the coin in FIG. 7A;

FIG. 7C is a plot showing the surface of the coin in FIG. 7A;

FIG. 7D is an image showing a structural image of a painting;

FIG. 7E is a 2-dimensional (2D) view showing a surface topography of the painting in FIG. 7D; and

FIG. 7F is a plot showing the surface of the painting in FIG. 7D.

### DETAILED DESCRIPTION

In general, optical coherence tomography (OCT) is an imaging technique used mostly in medical imaging applications that utilizes light to capture micrometer-resolution, and three-dimensional images from within optical scattering media (e.g., biological tissue). OCT is based on low-coherence interferometry, typically employing near-infrared light or other such light sources. The use of relatively long wavelength light allows it to penetrate into the scattering medium.

OCT is one of a class of optical tomographic techniques. Commercially available OCT systems are employed in diverse applications, including art conservation and diagnostic medicine, notably in ophthalmology and optometry where it can be used to obtain detailed images from within the retina. Recently, it has also begun to be used in interventional cardiology to help diagnose coronary artery disease. It has also shown promise in dermatology to improve the diagnostic process.

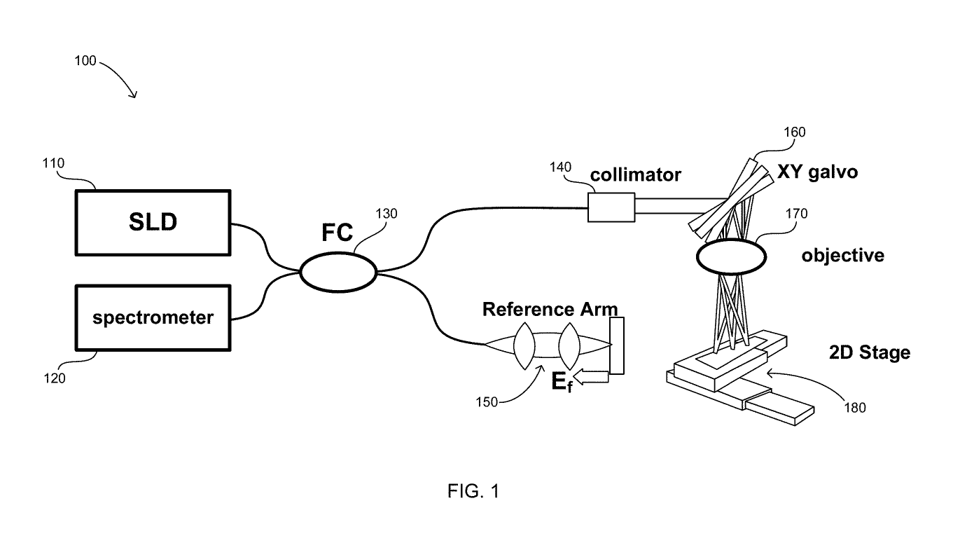

FIG. 1 shows a spectral domain OCT (SD-OCT) system 100 according to an embodiment of the present invention for 3D imaging various samples such as an object 170. Prior publications give further details about this system and are described in previous publications [13 and 14]. In this embodiment, the SD-OCT system 100 has a super luminescent diode (SLD) 110 as the broadband light source. This SLD may be, for example, SLD1325 Thorlabs, 1.3 μm central wavelength and 100 nm bandwidth, with power smaller than 10 mW at the sample. A spectrometer 120 may be used with the SLD, and the spectrometer is used for measuring wavelengths of light spectra. The output of the SLD 110 illuminates a sample arm 140 or a reference arm 150 of a fiber-optic interferometer through a fiber-optic coupler (FC) 130. A lens is used in the sample arm to focus the probing beam and collect photons backscattered from the sample. A collimator 140 is used for producing a parallel beam of rays or radiation as shown in FIG. 1.

Sufficiently large distance between the SD-OCT system's imaging optics and the surface of the sample prevents potential damage due to collision. Light exposure is kept at a minimum to avoid light introduced degradation [1]. Light returned from the sample and the reference mirror interferes and is detected by a detector such as a CMOS InGaAs camera (SUI1024LDH2, Goodrich). A frame grabber (PCIe-1433, National Instrument) may be used to stream the signal from the camera to a host computer (e.g., Dell Precision T7600) where the OCT signal is processed in real-time using GPU. The theoretical axial resolution (δz) of the OCT system is determined by the central wavelength of the light source (λ0=1.3 μm) and the bandwidth of the light source (Δλ=100 nm): δz=0.44λ02/Δλ=7.4 μm. The axial point spread function of the system was characterized using OCT data obtained from a mirror and estimated the axial resolution to be 8 μm. In addition, the OCT system has a 2.5 mm imaging depth and 92 kHz Ascan rate determined by the camera. The OCT system according to the present invention could achieve an 8 μm lateral resolution when a high numeric aperture scanning lens (LSM02, Thorlabs) is used. When a lens with larger focal length (f=60 mm) is used to image a painting, the lateral resolution is estimated to be 26 μm.

A pair of galvanometers steers the light beam to perform lateral scanning. The lateral FOV of the OCT system may be determined by the maximum deflecting angle (αmax) of the galvo mirror 160 and the focal length (F_{obj}) of the objective lens 170: FOVₘₐₓ≈2αₘₐₓF_{obj} where αmax is determined by the specification of the galvanometer. It is clear that a large lateral FOV can be achieved by using an objective lens with large focal length. However, such a lens is either bulky, or has a small numeric aperture (NA) that compromises the lateral resolution for OCT imaging. To simultaneously achieve large lateral FOV and microscopic resolution for the examination of the oil painting, the embodiment of the SD-OCT system provides a pair of linear motors (e.g., Newport, ILS100CC DC) that can translate in two orthogonal directions creating a 2D stage system 180. The sample to be examined may be attached to the 2D stage system 180 and be translated in two orthogonal directions. The motor may have an accuracy (on-axis accuracy of ±2 μm) that is high enough to be compatible with the lateral resolution of the OCT system. Volumetric OCT data from different regions of interests (ROIs) are taken by moving the linear motors in X and Y directions. The motors remain still during OCT data acquisition. After data acquisition from the current ROI is accomplished, the motors translate to the adjacent ROI to acquire additional volumetric OCT data. The acquisition of OCT data and the translation of the motor are controlled by the in-house developed software. The motor is translated to spatial coordinates predetermined in the software.

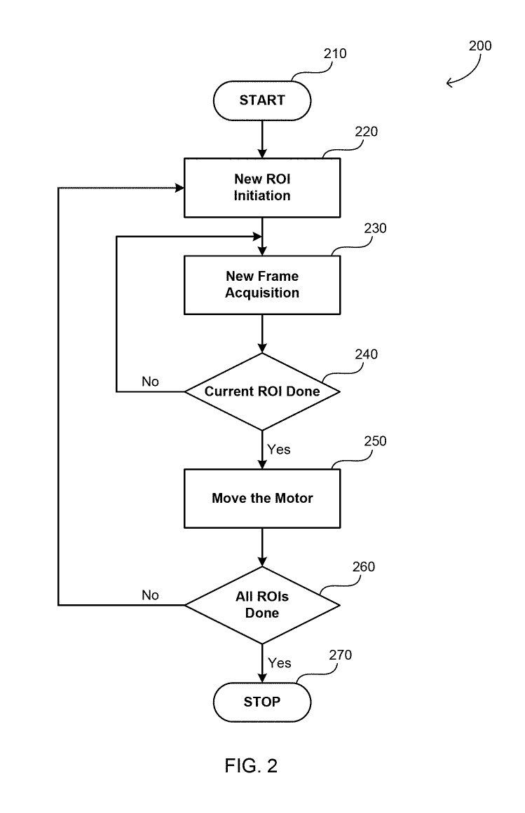

The data acquisition procedure 200 for a large FOV OCT imaging system is illustrated in FIG. 2. Block 210 represents the start of the procedure and initiation phase by a user. A new region of interest (ROI) is initiated as the motors translate to the new ROI, as represented in block 220. The next step in the procedure is new frame acquisition, which is data acquisition at the current ROI, as represented by block 230. A query is made in block 240 as to whether the data acquisition of the current ROI is done. If the current ROI is done, then the motors move as represented in block 250. If the current ROI is not done, then new frame acquisition 250 is repeated. After the motor is moved as shown in block 250, another query is made as to whether all ROIs are done as shown in query box 260. If all the ROIs are done then the procedure stops as shown in block 270. If all the ROIs are not done then the procedure goes back to a new ROI initiation shown in block 220 and the process is repeated.

To determine the displacement of the motor during OCT data acquisition, it is calculated for a lateral FOV of a single OCT image in x and y directions: FOV1ₐₜₑᵣₐₗ=2βVF_{obj}, where β is the galvanometer's responsive factor, V is the voltage applied to the galvanometer and βV is the galvanometer's deflection angle. An achromatic doublet is used with anti-reflective coat in near infrared range as the imaging objective and F_{obj} was 60 mm. The motors are programmed so that they moved in x and/or y directions with the displacement equivalent to FOVₗₐₜₑᵣₐₗ. Notably, the imaging time increased proportionally as the FOV increased, because multiple ROIs were scanned sequentially. However, the longer scanning time did not affect the quality of acquired OCT signal, because the samples were static. This is significantly different from in vivo animal or human imaging where reduced temporal resolution may result in motion artifact.

To process massive data streamed from the OCT engine at 92 kHz linescan rate, high-speed software is developed based on a GPU for the OCT image reconstruction. Individual Ascans may be processed by individual cores of the GPU in parallel (NVIDIA Geforce GTX 780, 2304 CUDA cores at 0.9 GHz, 3 GB graphics memory), resulting in significant improvement in data processing speed compared to CPU based computation. Briefly, spectral data is linearized in wave number space and a fast Fourier transform (FFT) was applied to obtain an Ascan. Once an Ascan is reconstructed, the signal amplitude is averaged in each Ascan, to convert the volumetric OCT data into a two-dimensional enface image for visualization. For surface topology characterization, the signal peak is searched for each Ascan. The same signal processing procedures are applied to all the Ascans individually. Therefore, the parallelization of signal processing can be accomplished.

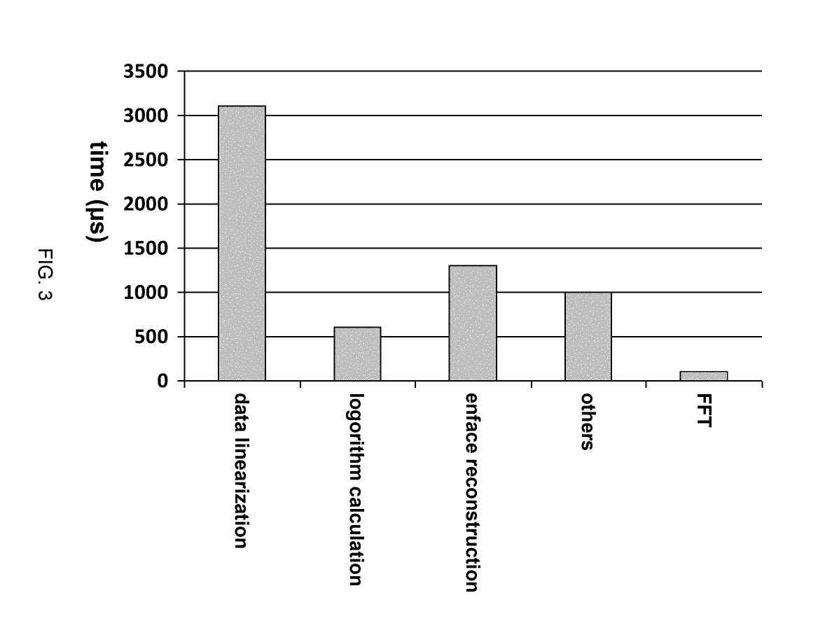

The signal processing speed was analyzed using NSight by NVIDIA and results are shown in FIG. 3. The time cost analysis was obtained by averaging a batch of Ascans. It was challenging to determine the maximum processing speed, because it depends on the GPU hardware as well as the algorithm that implements parallel computation. Nevertheless, Multi-megahertz Ascan processing rate has been reported and the processing speed obtained can be significantly improved through code optimization. Nevertheless, the data acquisition speed was the main limiting factor of the present OCT system rather than signal processing speed.

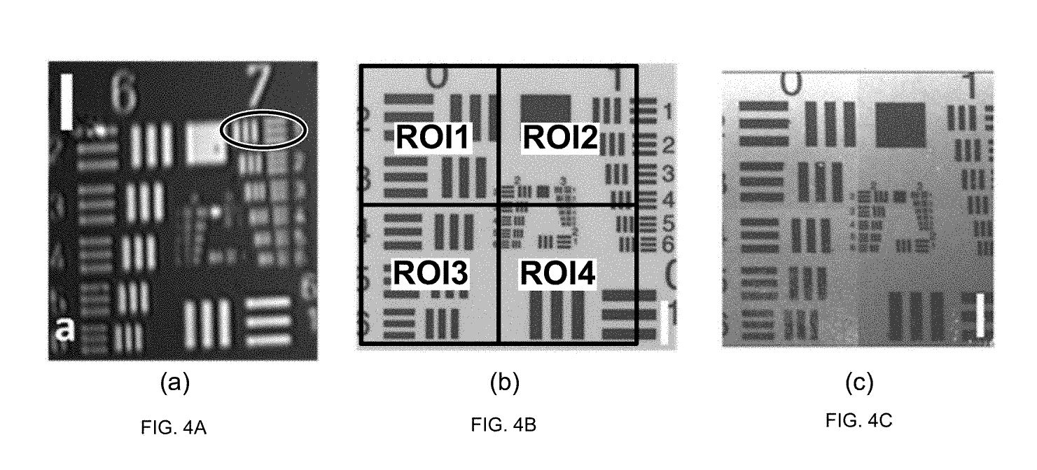

To demonstrate the high resolution of the present OCT system for HD examination of artworks, a HD OCT imaging is performed using a lens with 18 mm effective focal length as the objective (LSM02, Thorlabs) on 1951 air force resolution target (1951 USAF Glass Slide Resolution Targets). An enface image obtained by averaging the volumetric OCT signal in axial direction is shown in FIG. 4A. The first element of the seventh group in the resolution target is clearly discernable, as indicated by the oval in FIG. 4A. This suggests the lateral resolution of the imaging system could be as high as 8 μm. A macroscopic sample (Pocket USAF Optical Test Pattern, Edmund Optics) is used to validate OCT images obtained by the data acquisition procedure shown in FIG. 2 could accurately reveal the structural features of the sample in an extended FOV. The photo of the resolution target is shown in FIG. 4B. A volumetric OCT data is acquired sequentially from different areas, ROI 1, 2, 3 and 4. The OCT signals are then averaged along depth direction and show the resultant enface image in FIG. 4C. The consistency between FIGS. 4B and 4C suggests that large FOV OCT imaging can be achieved by mosaicking multiple volumes of OCT data together. Scale bars in FIGS. 4B and 4C indicate 0.5 mm.

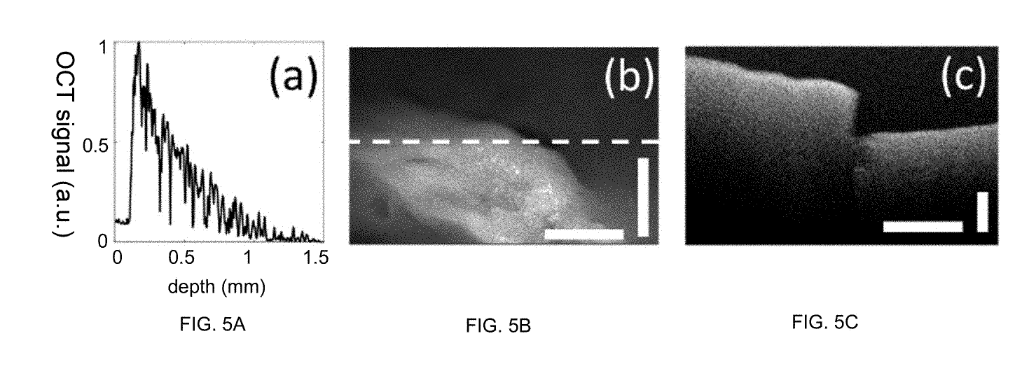

A 3D OCT imaging was demonstrated with extended lateral FOV of a painting by a local artist. Acrylic paint is applied onto canvas, and in order to mimic the paint style of impressionist era where surface depth and pigment mixture varies from point to point, multiple layers are overlapped at different time intervals. FIG. 5A shows an Ascan acquired from the painting, indicating that the present OCT system has sufficient penetration depth to reveal the subsurface microstructure of the painting. FIG. 5B represents the enface image obtained from the oil painting by averaging volumetric OCT data along the axial direction. FIG. 5C shows the B scan obtained from the painting along the dotted line in FIG. 5B. The abrupt change in the surface position in the center of FIG. 5C reveals the paint thickness difference between the two adjacent brushstrokes. Scale bars in FIGS. 5B and 5C indicate 0.5 mm. It is worth mentioning that the magnitude of OCT signal at a specific location depends on the light scattering and absorption at near infrared range where the OCT system is operated. The OCT signal is not directly related to the color, because the color reflects the spectroscopic characteristics of the sample within the visible, rather than near infrared band of light.

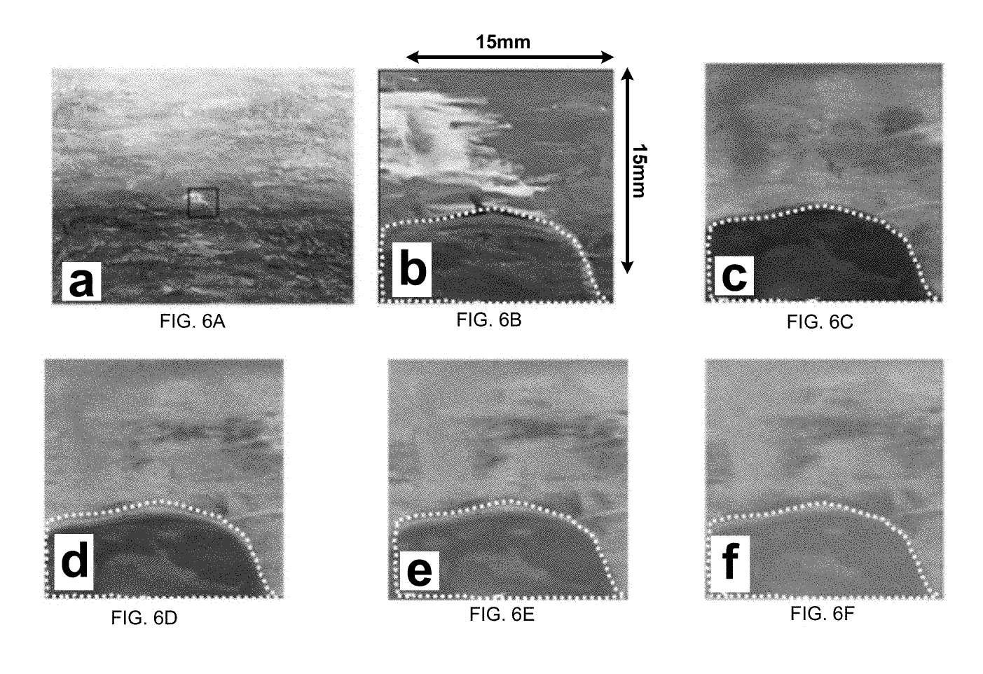

The OCT system of the present invention is used to scan a sample painting (175 mm by 140 mm), the photo of which is shown in FIG. 6A. Two features are captured. The enface scans of the painting are generated to reveal the painting process and techniques of the specific artist; the 3D model of the paint surface is generated to show the details of the brush stroke, which has a distinct style for the impressionist paintings. Previous work [8] has demonstrated that OCT is capable of achieving higher resolution in capturing under layers than infrared cameras. The sub-region of the painting scanned is shown in FIG. 6B. To achieve the 15 mm by 15 mm FOV, it was sequentially acquired volumetric OCT data from four adjacent areas as shown in FIG. 4B. The resultant large FOV enface images are generated, as shown in FIGS. 6C-6F, by averaging pixel values within different depth range. As shown in FIGS. 6C-6F, the area within the dotted line shows different characteristics compared to the surrounding area. In FIG. 6C, the OCT signal level in this region is lower than the surrounding area. This is because the paint thickness in this region is lower than its surroundings. The contrast between the encircled area and the surrounding area fades as the depth of the enface image increases from FIGS. 6C to FIG. 6E, and in FIG. 6E, the signal level is similar to its surroundings.

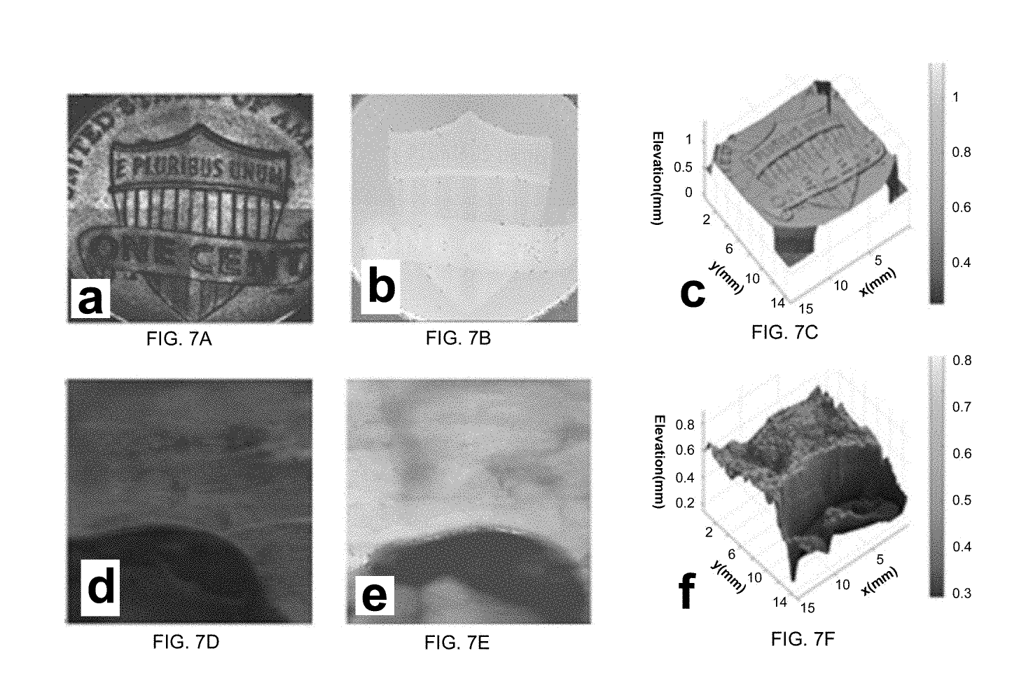

In addition to enface visualization of subsurface structure, the 3D OCT data may also be used to render the surface topology of the painting, which captures the brush stroke characteristic of the painter. Peak search was performed for each Ascan in the software based on GPU. As shown in FIG. 5A, the peak in the Ascan is generally located at the surface of the sample. Using the axial location of Ascan peak identified for each Ascan, a precise mapping of the surface terrain for the painting can be generated. The method for surface topology mapping was validated using a coin. The enface image of the coin is shown in FIG. 7A. For each Ascan, the peak positon in real-time is determined and the results is shown as a 2D image in FIG. 7B. The surface terrain is also shown as 3D mesh in FIG. 7C. Afterwards, the surface topology characterization on the painting was performed. The enface image, 2D representation of peak position and 3D mesh representation are shown in FIGS. 7D, 7E and 7F. The images shown in FIGS. 7A-7F were obtained with extended FOV. As shown in FIG. 7F, there is a visible thickness difference between two adjacent brushstrokes, which coincides with our conclusion in FIGS. 6A-6F.

A larger FOV, spectral domain OCT imaging system for the examination of paintings is provided using the present invention. The motion of the two linear motors may be controlled to obtain 3D OCT data from multiple areas adjacent to each other but non-overlapping. The high-speed software developed for the present invention for signal processing and image display worked is able to acquire images from various penetration depths within the sample, demonstrating that OCT has the capability to reveal the subsurface microstructures that are not normally visible in a 2D digital imaging system. Moreover, detailed surface features of the sample can also be detected from the 3D rendering surface topology. Therefore, a non-invasive, high definition and high speed OCT system provided by the present invention can be used as an alternative way for the microscopic examination of cultural heritage works in a macroscopic scale. Assuming that the volumetric OCT data is acquired from a 40 inch by 40 inch painting with 300 dpi and each lateral position corresponds to an Ascan with 1024 2-Byte pixels, it is estimated that the volume of OCT data for the painting is 300 GB. Assuming that the estimated storage cost is $0.03/GB, the cost of the storage of a digitized painting is approximately $10 and can be further reduced in the future.

Notably, in the example provided herein, the FOV is extended for OCT imaging with a factor of 4, by sequentially acquiring images from four adjacent, non-overlapping areas. To further increase the FOV, the motors may be translated to additional lateral coordinates for OCT data acquisition. This can be achieved simply by modifying the software used to position the motors and acquire OCT data. The upper limit of FOV is determined by the travel range of the motor.

The data acquired by the present OCT imaging system provides both 3D surface information of the object and structure information underneath the surface. Cross-sectional information of heritage works can be utilized to study layer structure of the painting and brush stork techniques used by the artist. HD examination of heritage works needs to scan large areas and process huge amount of data. The present high-speed, large FOV OCT imaging platform provides a large FOV and sufficient processing power. This present OCT platform may be used as a nondestructive alternative for the analysis and conservation of heritage works such as paintings and murals.

As will be clear to those of skill in the art, the embodiments of the present invention illustrated and discussed herein may be altered in various ways without departing from the scope or teaching of the present invention. It is the following claims, including all equivalents, which define the scope of the invention.

### REFERENCES

1. ICOMOS China. Principles for the Conservation of Heritage Sites in China. Rev. ed. Beijing: Wen wu chu ban she, 2015.

2. M. Pieraccini, G. Guidi, and C. Atzeni, “3D digitizing of cultural heritage,” Journal of Cultural Heritage 2, 63-70 (2001).

3. M. Schreiner, B. Frühmann, D. Jembrih-Simbürger, and R. Linke, “X-rays in art and archaeology: An overview,” Powder Diffr. 19, 3-11 (2004).

4. D. N. H. Notman, J. Tashjian, A. C. Aufderheide, O. W. Cass, O. C. Shane, T. H. Berquist, J. E. Gray, and E. Gedgaudas, “Modern imaging and endoscopic biopsy techniques in Egyptian mummies,” Am. J. Roentgenol. 146, 93-96 (1986).

5. D. Huang, E. A. Swanson, C. P. Lin, J. S. Schuman, W. G. Stinson, W. Chang, M. R. Hee, T. Flotte, K. Gregory, C. A. Puliafito, and J. G. Fujimoto, “Optical coherence tomography,” Science 254,1178-1181 (1991).

6. J. G. Fujimoto, C. Pitris, S. A. Boppart, and M. E. Brezinski, “Optical Coherence Tomography: An Emerging Technology for Biomedical Imaging and Optical Biopsy,” Neoplasia 2(1-2), 9-25 (2000).

7. A. M. Zysk, F. T. Nguyen, A. L. Oldenburg, D. L. Marks, and S. A. Boppart, “Optical coherence tomography: a review of clinical development from bench to bedside,” J Biomed Opt 12, 051403 (2007).

8. H. Liang, M. G. Cid, R. G. Cucu, G. M. Dobre, A. G. Podoleanu, J.Pedro, and D. Saunders, “En-face optical coherence tomography—a novel application of non-invasive imaging to art conservation,” Opt. Express 13, 6133-6144 (2005)

9. P. Targowski, M. Góra, and M. Wojtkowski, “Optical Coherence Tomography for Artwork Diagnostics,” Laser Chem 2006, 1-11 (2006).

10. T. Arecchi, M. Bellini, C. Corsi, R. Fontana, M. Materazzi, L. Pezzati, and A. Tortora, “A new tool for painting diagnostics: Optical coherence tomography,” Opt. Spectrosc 101, 23-26 (2006).

11. H. Liang, R. Lange, H. Howard, and J. Spooner, “Non-invasive investigations of a wall painting using optical coherence tomography and hyperspectral imaging,” Proc. SPIE, vol. 8084. p. 80840F-80840E-7, 2011.

12. K. Zhang and J. U. Kang, “Real-time 4D signal processing and visualization using graphics processing unit on a regular nonlinear-k Fourier-domain OCT system,” Opt. Express 18(11), 11772-11784 (2010).

13. X. Liu, M. Kirby, and F. Zhao, “Motion analysis and removal in intensity variation based OCT angiography,” Biomed. Opt. Express 5, 3833-3847 (2014).

14. Y. Wang, Y. Wang, A. Akansu, K. D. Belfield, B. Hubbi, and X. Liu, “Robust motion tracking based on adaptive speckle decorrelation analysis of OCT signal,” Biomed. Opt. Express 6(11), 4302-4316 (2015).

15. H. Liang, B. Peric, Michael Hughes, Adrian Podoleanu, Marika Spring, David Saunders, “Optical coherence tomography for art conservation and archaeology,” Proc. SPIE, vol. 6618, p. 661805, 2007.

1. A high definition optical coherence tomography (OCT) imaging system for non-invasive examination of an artwork, comprising:
a high-speed, large field-of-view (FOV) OCT imaging platform including:
a spectral domain OCT imaging system having a lateral resolution for imaging the artwork; and
a pair of linear motors configured to be attached to the artwork for translating the artwork in two orthogonal directions creating a 2D stage system for scanning the artwork and acquiring volumetric OCT data including spectral data from adjacent, non-overlapping Regions of Interests (ROIs) on the artwork, the linear motors each having an accuracy compatible with the lateral resolution of the OCT system, the linear motors remaining still during the spectral data acquisition;
whereby a high-speed, large FOV OCT imaging is achieved and the lateral resolution of OCT imaging is not compromised.

2. The system according to claim 1, wherein the imaging platform further includes a Graphic Processing Units (GPU), wherein an Ascan from each optical interface are obtained by a Fourier domain configuration of the spectral domain OCT imaging system based on the spectral data acquired, the signals from each optical interface being processed by an individual core of the GPU, thereby enabling parallel signal processing.

3. The system according to claim 1, further comprising an achromatic doublet with an anti-reflective coat in near infrared range used as an imaging objective having a focal length (F_{obj}) of 60 mm.

4. The system according to claim 1, wherein after data acquisition from a current ROI is accomplished, the motors translate to an adjacent ROI to acquire additional volumetric OCT data.

5. The system according to claim 1, wherein the acquisition of OCT data and translation of the motors are controlled by a software program.

6. The system according to claim 1, wherein the motors are translated to pre-determined spatial coordinates.

7. The system according to claim 1, wherein the motors are programmed so that movement is in x and/or y directions with a displacement equivalent to the FOV.

8. The system according to claim 1, further including a pair of galvanometers for steering a light beam to perform lateral scanning.

9. The system according to claim 7, wherein the FOV is determined by the maximum deflecting angle (αₘₐₓ) of a galvanometer and a focal length (F_{obj}) of an objective lens, wherein αₘₐₓ is determined by a specification of the galvanometer.

10. The system according to claim 1, wherein a displacement of the motors during the spectral data acquisition is calculated based on a FOV of a single OCT image in the two orthogonal directions: FOV=2βVF_{obj},
wherein β is a galvanometer's responsive factor,
V is voltage applied to the galvanometer,
βV is the galvanometer's deflection angle, and
F_{obj} is a focal length of an objective lens.

11. The system according to claim 1, wherein the motors have an accuracy on-axis accuracy of ±2 μm.

12. The system according to claim 2, wherein the Ascan signals reveal both a surface profile and an under layer structural information of the artwork.

13. The system according to claim 12, wherein the amplitude of each Ascan signal is averaged to convert volumetric OCT data into a 2D enface image for visualization.

14. The system according to claim 12, wherein a peak search is performed for each Ascan producing the surface profile.

15. The system according to claim 2, wherein a series of the Ascan signals are obtained across the structure of the artwork, generating a cross-sectional information Bscan of the artwork.

16. The system according to claim 1, wherein an upper limit of the FOV is determined by a travel range of the motor.

17. A method of performing non-invasive examination of an artwork using a high definition optical coherence tomography (OCT) imaging system, the method comprising the steps of:
providing a high-speed, large field-of-view (FOV) OCT imaging platform including:
a spectral domain OCT imaging system having a lateral resolution for imaging the heritage works; and
a pair of linear motors for translating the artwork in two orthogonal directions creating a 2D stage system for scanning the artwork and acquiring volumetric OCT data including spectral data from adjacent, non-overlapping ROIs on the artwork, the linear motors each having an accuracy compatible with the lateral resolution of the OCT system, the linear motors remaining still during the spectral data acquisition;
performing a lateral scanning of a Region of Interest (ROI) on the artwork to acquire volumetric OCT data of the artwork using the OCT imaging platform;
translating, by the motors, the artwork to an adjacent non-overlapping ROI to acquire additional volumetric OCT data of the artwork; and
constructing surface topology and subsurface microstructure of the artwork based on the volumetric OCT data acquired.

18. The method according to claim 17, further comprising the step of:
performing a fast Fourier transform (FFT) to obtain an Ascan signal based on the volumetric OCT data acquired.

19. The method according to claim 18, wherein each Ascan signal is processed by an individual core of a Graphic Processing Unit (GPU) in parallel.

20. The method according to claim 17, further comprising the step of:
obtaining a series of Ascan across a structure of the artwork for generating a cross-sectional Bscan.
